(19) United States
(12) Patent Application Publication
(10) Pub. No.: US 2013/0177898 A1
(43) Pub. Date: Jul. 11, 2013

(54) Method of Treating Organs

(71) Applicants: John Brassil, Northbrook, IL (US); Alan Rhodes, Richmond, CA (US)

(72) Inventors: John Brassil, Northbrook, IL (US); Alan Rhodes, Richmond, CA (US)

(21) Appl. No.: 13/542,488

(22) Filed: Jul. 5, 2012

Related U.S. Application Data
(60) Provisional application No. 61/504,654, filed on Jul. 5, 2011.

(51) Int. Cl. A01N 1/02

(52) U.S. Cl. CPC A01N 1/0294
USPC 435/1.2; 435/1.1

(57) ABSTRACT

A method of treating tissue, including organs, with electromagnetic energy to decrease the fat content of the tissue comprises the steps of providing a source of electromagnetic energy, and subjecting adipose cells to the source of electromagnetic energy at hypothermic conditions. The tissue may be harvested and in an isolated state, such as being placed in an organ preservation system. Electromagnetic energy between 600 nm to 700 nm is used for treatment. During treatment, target tissue such as a harvested organ is subject to perfusion.

This application claims the benefit of U.S. Provisional Patent Application Ser. No. 61/504,654, filed on Jul. 5, 2011 and titled “Method of Treating Organs.”

### FIELD OF THE INVENTION

This invention relates to the treatment of organs or tissue with electromagnetic energy.

### BACKGROUND OF THE INVENTION

Being able to decrease fat content in an organ or tissue to a particular level can be beneficial in various circumstances. Where tissue or organ with lower fat content is desired, but not available, the supply of suitable tissue or organ can be increased if the fat level of otherwise unsuitable tissue or organ is decreased. This is particularly useful in medical research where tissue or organ samples may be costly and/or difficult to obtain.

In organ transplantation, organs that would otherwise be unsuitable for transplantation due to their high fat content can be treated to decrease their fat content to acceptable levels. Liver transplantation is a subset of the numerous organ transplantations that are performed in the U.S. each year which would benefit greatly with a method of decreasing the fat content of the organ. As with any type of organ transplantation, a shortage of suitable donors and suitable organs contribute to the difficulties of performing a liver transplantation surgery to those in need of a liver transplant. Thus, it is desirable to increase the number of suitable organs, and to minimize organ damage to harvested organs.

Current techniques for preservation of organs prior to transplantation, and post-transplant, have included the use of electromagnetic energy to stimulate tissue to produce desirable effects. For example, in U.S. Pat. No. 7,316,922, electromagnetic energy is delivered to a harvested organ to generate a biostimulative effect which can prevent or retard damage to the tissue. Organs in situ can also be stimulated by light energy. U.S. Pat. No. 6,663,659 utilizes light energy which is implanted near an organ to improve the function of the organs. In some circumstances, the fat content of a potential donor organ is too high to be suitable for transplantation. Thus, it is desirable to decrease the fat content in organs such as a liver. Steatotic livers, otherwise known as fatty livers, are nowadays limited in usefulness for transplantation because they have an unacceptably high rate of non-function post-transplant. Studies suggest that higher transplantation rates can be achieved if fat can be removed from a liver prior to transplantation.

The present inventor has recognized the need for a method of decreasing the fat content in biological tissue.

The present inventor has recognized the need for an efficient method of decreasing fat content in biological tissue at hypothermic conditions.

The present inventor has recognized the need for a method of decreasing fat content in biological tissue simultaneously with perfusion.

The present inventor has recognized the need to stimulate tissue or organs in isolated state with electromagnetic radiation to produce beneficial effects.

### SUMMARY OF THE INVENTION

A method of treating tissue, including organs, with electromagnetic energy to decrease the fat content of the tissue comprises the steps of providing a source of electromagnetic energy, and subjecting adipose cells to the source of electromagnetic energy at hypothermic conditions. The tissue may be harvested and in an isolated state, such as being placed in an organ preservation system.

In one embodiment the source of electromagnetic energy is a laser. The laser may be the laser described in U.S. Pat. No. 6,605,079 herein incorporated by reference, capable of emitting electromagnetic energy between the wavelengths of 600 nm to 700 nm. The electromagnetic energy may be applied to the surface of the tissue, via needle puncture to a particular location, or intraluminally.

In another embodiment, the source of electromagnetic energy is a light emitting diode (LED), such as a LED capable of emitting known and stable wavelengths. In other embodiments more than one source of electromagnetic energy can be used, such as the use of an array of LEDs or a combination of LEDs and lasers.

The application of electromagnetic energy to tissue and organs can be simultaneous with perfusion of the tissue or organ, such as prior to organ transplantation. Alternatively, electromagnetic energy can be applied to the organ or tissue post-transplantation.

In other embodiments, the invention provides a method of treating biological tissue, including organs, with electromagnetic irradiation to effectuate beneficial physiological changes, such as structural and/or chemical changes, which can render the biological tissue more suitable for transplant. The electromagnetic irradiation can be applied to the surface of the tissue, or interluminally, or via needle puncture.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 illustrates the intensity plot of an individual laser emitter.

FIG. 2 illustrates the intensity plot of one exemplary embodiment of an arrangement of an array of four laser emitters.

FIG. 3 illustrates a three dimensional intensity plot of the array of four laser emitters of FIG. 2.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

In one embodiment, laser energy, preferably in the red or infrared wavelength, such as 630 nm to 850 nm in wavelength, or 630 nm to 640 nm in wavelength, or 635 nm in wavelength, is applied to the desired treatment area of the biological material. The biological material can be a tissue or an organ, such as, for example, a liver. The desired wavelength is applied to the treatment area of the organ with energy of approximately 10 mW. Without wishing to be bound by any particular theory, it is believed that irradiation of adipose tissue with electromagnetic wavelength between 630 nm to 850 nm targets adipose cells selectively and non-destructively. The treatment with electromagnetic waves causes the cells to create micropores such that fat within the cells can be released into intercellular space to be carried away. Because the adipose and parenchymal cells remain viable and intact, inflammation and toxicity which typically occurs if the cells were destroyed, is minimized.

The source of electromagnetic energy can be a laser, LED, or any other suitable source, or a combination thereof. The source of electromagnetic energy is not limited to coherent light. Other light sources of known and/or specific wavelength can also be used. Gaussian beam modeling can be used to simulate and analyze the additive effects of multiple beams to determine the relative peak and trough illumination at the tissue. By taking into consideration irradiation parameters such as intensity of the source, beam divergences, arrangement of each source of electromagnetic energy, and distance from the source to the target tissue, electromagnetic energy of uniform intensity within a desired intensity range can be achieved at the surface of the target tissue. Beam modeling can also be used to determine the optimal positioning of various sources of electromagnetic energy to achieve a desired intensity range at the surface of the target tissue, such as when the surface of the target tissue is uneven but uniform intensity is desired.

In one embodiment where more precise targeting of the fatty tissue is desired, the electromagnetic energy may be applied via a needle puncture, or via fiber optic waveguide or bundle. The waveguide or bundle may be disposed to terminate at or pass through a particular volume or zone of tissue by inserting the fiber optic waveguide or bundle into the lumen of a vessel such as an artery, vein, duct or other luminal structure and directing the waveguide or bundle through the vasculature or ductal structure to the desired location. Alternatively the fiber optic waveguide or bundle may be positioned at the desired location through the lumen of a needle or cannula. Electromagnetic energy delivered via fiber optic cable waveguide or bundle to a treatment location can have specified characteristics, such as having a particular focal distance, energy density, direction of emission, such as, for example, an axial, or side firing direction, as well as any other emission characteristic. Any other suitable characteristic or mechanism known to one skilled in the art for delivering electromagnetic energy can also be used.

In one embodiment, electromagnetic irradiation of the target tissue is pulsed. The time period between pulses of electromagnetic radiation can be at least 5 milliseconds, or at least 10 milliseconds, or at least 20 milliseconds. In other embodiments, the pulse of electromagnetic energy is pulsed in coordination with pulsation of perfusion pressure. The coordination of the electromagnetic energy pulses and the pulses of perfusion pressure may be coordinated to be in synchronization, or out of synchronization, or any other suitable relative frequency. In one embodiment, the frequency of pulsation of electromagnetic energy and pulsation pressure are related by a factor of an integer value. In certain circumstances, the coordination of pulse intensity with perfusion pressure phase can lead to beneficial results.

In one embodiment, the irradiation of the target tissue or organ occurs when the target tissue or organ is removed from the physiological environment and placed in an environment which maintains the viability of the tissue or organ. One suitable treatment environment is an organ perfusion system, such as the Model 30 perfusion machine from Functional Circulation, LLC of Northbrook, Ill., or the organ preservation system described in U.S. Patent Application Publication 2011/0076666 herein incorporated by reference. The treatment environment is one suitable for isolated organ or tissue preservation, such as an aseptic environment involving isolated hypothermic perfusion of the organ or tissue.

The perfusion interval may vary depending on the type of organ or tissue, the perfusate, and various other perfusion parameters. The perfusion interval may be up to 11 hours, or can be less than 11 hours. In some circumstances, isolated organs may need to be perfused for a duration of more than 11 hours. Energy of approximately 10 mW can be applied to the organ for a duration equal to the duration of the perfusion interval. Other suitable energy levels can also be used depending on the duration of perfusion.

Experimentation on fatty tissue illustrates the effect of low level light therapy on adipose tissue under hypothermic conditions and ambient conditions. Solid bovine adipose tissue of 1 cm by 1 cm by 2 mm were placed on absorbent paper for the duration of the experiment. Adipose tissue was exposed to various degrees of LED light intensity. The LEDs emitted a monochromatic wavelength of 635 nm, at 10 mW with a luminosity of 2.5 Cd. Adipose tissues were separated into six groups, with Groups 1-3 exposed to hypothermic conditions of 4 degrees Celsius. Experimentation with Groups 4-6 were conducted at 21 degree Celsius. The LEDs in the experiments were either turned off, on, or turned on but covered with foil to serve as a control for heat effects.

TABLE 1
Experimental Conditions

| | Description |
|---|---|
| Temperature 4 deg. Celsius | |
| Group 1 | LED off |
| Group 2 | LED on |
| Group 3 | LED covered |
| Temperature 21 deg. Celsius | |
| Group 4 | LED off |
| Group 5 | LED on |
| Group 6 | LED covered |

Stains on the absorbent paper at the conclusion of the experiment were considered to be fat components which had been removed from the adipose tissue. The surface area of the stains were measured at the conclusion of each experiment to determine the amount of fat content released. It is presumed that the surface area of the stains are proportional to the amount of fat content released from the adipose tissue.

Results, summarized in the table below, indicate the unexpected result of a greater fat content release at hypothermic conditions as a result of irradiation of electromagnetic energy.

TABLE 2
Results

| Group | N | Average Area (sq-mm) |
|---|---|---|
| 1 | 4 | 2725 |
| 2 | 4 | 3956 |
| 3 | 4 | 3396 |
| 4 | 2 | 4588 |
| 5 | 2 | 6706 |
| 6 | 3 | 7331 |

As indicated by the results in Table 2, Group 3 comprising of adipose tissue subjected to monochromatic light of 635 nm wavelength under hypothermic conditions experienced the greatest amount of fat content release under hypothermic conditions. Under non-hypothermic conditions, Group 5 of adipose tissue subjected to monochromatic light of 635 nm wavelength, did not result in the highest release of fat. These results are unexpected and indicate that the use of cold laser therapy under hypothermic conditions is useful to decrease the fat content of pre-transplantation organs. Results also indicated that overall fat release is higher for each non-hypothermic group than their corresponding hypothermic group. The LED covered group served as a control for the thermal effects on the adipose tissue from the LED. Without wishing to be bound by any particular theory, it is believed that at hypothermic conditions, light effect of the LED correlates to an increased fat release than the heat effect of the LED, when compared to non-hypothermic conditions. A correlation between irradiation with electromagnetic energy and fat release at hypothermic conditions has been found. Results of the experiment indicates that fat can be depleted from organs such as the liver without raising the temperature of the liver, through the use of electromagnetic irradiation. The discovery of this correlation allows for organs, such as the liver, to remain at hypothermic preservation temperatures without the need to raise the temperature of the organ.

Pre-transplantation organs may be held in a sterile biological chamber at a pre-determined preservation temperature, such as under hypothermic conditions. Hypothermic conditions can be any temperature less than human body temperature. During preservation, electromagnetic irradiation can occur concurrently with perfusion, or can occur before or after perfusion. Perfusion concurrently with electromagnetic irradiation allows for perfusion to impart favorable preservation conditions to the organ, as well as provide an efficient pathway for removal of fat from the organ.

During perfusion, fluid is transmitted through the blood vessels or other luminal structures of the organ to preserve and/or provide living circulatory support to the isolated organ, as a surrogate or substitute for the normal circulation usually enjoyed by the living organ within the body. Perfusion of isolated tissue similarly provides exposure of the isolated tissue to fluid which simulates the physiological environment. During perfusion of an organ or isolated tissue, perfusion conditions may be adjustable to include regulation of metabolism, provision of life sustaining chemicals and substrates, provision of chromophores or other agents to affect the rate and or quality of the effect of electromagnetic energy, regulating the phase change or porosity of the cell membrane, and removal of the released fat molecules and other discardable materials away from the organ or tissue. Such removal of unwanted materials may be accomplished by dialysis, physical or chemical separation as would by normal in the art.

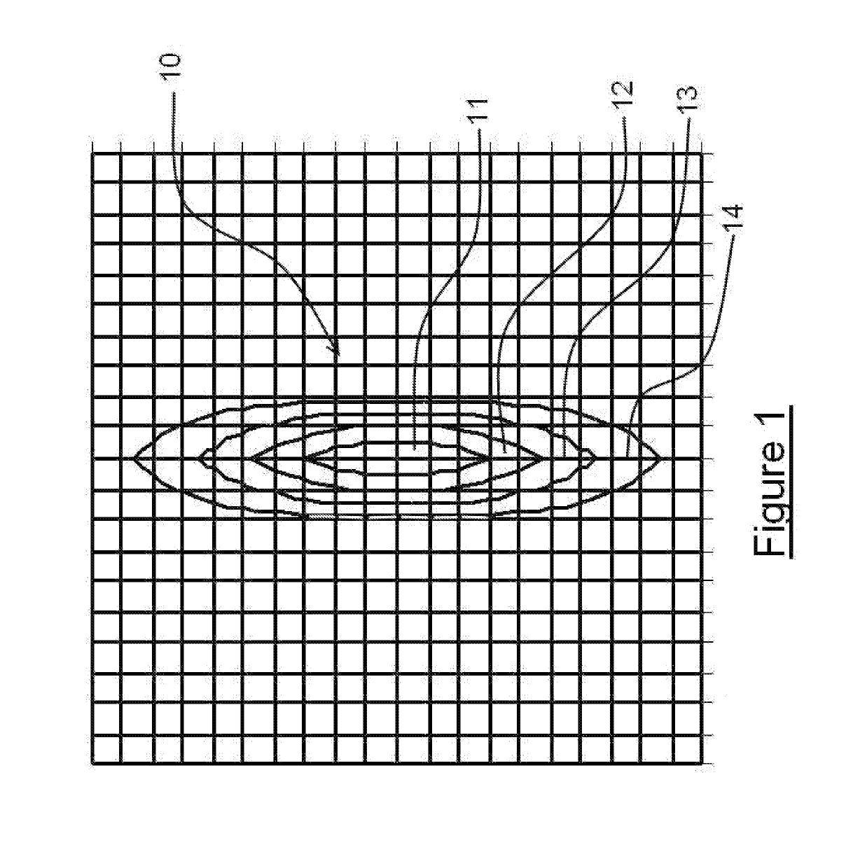

Illumination of target tissue with electromagnetic energy can be accomplished by combining or super imposing the effect of multiple light sources. FIG. 1 illustrates an intensity plot 10 from a single laser source, such as a laser emitter spaced 0.5 inches (1.25 cm) from the tissue, having a bean divergence of seven degrees and 30 degrees full width half maximum. The intensity plot 10 is elliptically shaped. The region of highest intensity is located at the central region 11 of the ellipse, with decreasing intensity as the distance from the central region increases at secondary intensity region 12, tertiary intensity region 13, and quaternary intensity region 14 respectively. Multiple light sources, such as more than one LED, or more than one laser, as well as a combination of multiple light source types, can be used to achieve a desired effect. Gaussian beam modeling is used to analyze the additive effects of multiple light sources to achieve the light intensity and/or uniformity profile desired.

To achieve intended coverage of illumination across the surface of the liver, the invention provides for the proper superimposition of multiple light sources, such as LEDs which are characterized by high divergence in a circular profile, or diode lasers which have low-divergence angle, elliptical, Gaussian beams. LED beams and laser beams are modeled at a specified distance away from the target tissue, and with various beam orientations to determine an optimal illumination across the surface of the tissue. Factors to consider when using Gaussian beam modeling include the shape and orientation of the beam, the divergence angle, the intensity of the beam, the distance from the target tissue, and the surface topology of the target tissue.

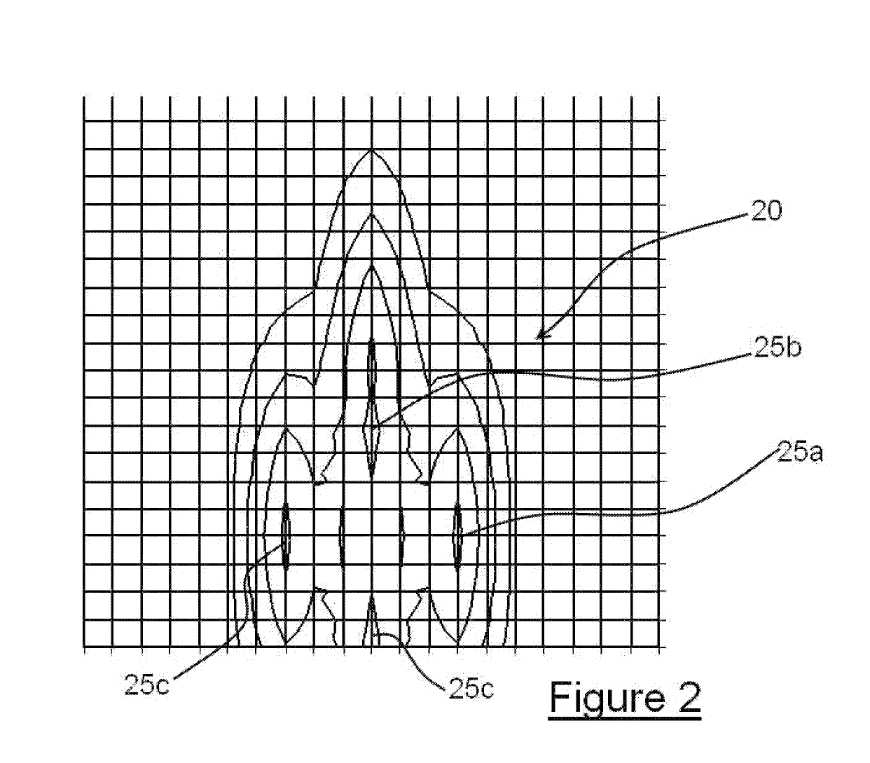

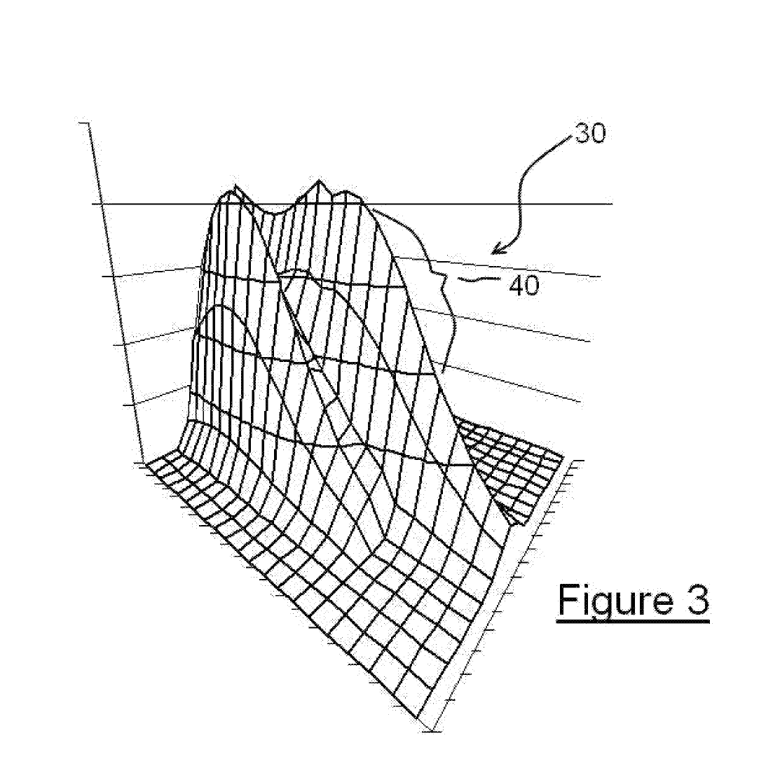

In one embodiment, an array of four laser emitters are arranged with the longitudinal axis of each emitter aligned. An array of four laser emitters each having an individual intensity plot as illustrated in FIG. 1, can be combined to provide the combined intensity plot 20 of FIG. 2. The regions of highest intensity 25a, 25b, 25c, 25d, as illustrated in FIG. 2, indicate the relative arrangement of the array of lasers. The secondary, tertiary, and quaternary intensity regions of each laser emitter are combined and overlapped to result in the intensity plot 20 of FIG. 2. FIG. 3 illustrates the intensity plot 30 of the combination of an array of the four lasers in three dimensional modeling. The laser emitters are be arranged such that the area of illumination is overlapping to maintain power over a predetermined area, within a predetermined range of power intensity. A zone of uniform intensity 40, within a predetermined range of intensity, can be extended with an increase in the number of emitters to the area. The zone of uniform intensity can also be shaped as desired by orienting the emitters within an array relative to each other. In one embodiment, the zone of relative uniformity is wherein the region of intensity is within 60% of maximum intensity. Other suitable values, such as 50% of maximum intensity, can be used for a zone of uniformity. Factors that affect the desired value within the zone of uniformity include the arrangement of fatty tissue, the surface contour and size of the target tissue, the amount of fatty tissue, and duration of treatment.

In one embodiment, the application of electromagnetic energy to biological cells can be used to provide anti-inflammatory effects and/or immune modulatory effects. Anti-inflammatory effects and/or immune modulatory effects may include the release of endogenous nitric oxide (NO), a powerful vasodilator, which may have beneficial effects for organ transplantation, such as the rapid establishment of sufficient blood flow within the organ. Factors affecting laser-tissue interaction known to one skilled in the art, including adjustment of wavelength, spot size and focus, divergence angle, pulse energy duration and frequency, spot scanning, as well as other factors and technique that determine results such as depth of effect, localization and specificity of effect, thermal lateral damage, vaporization, coagulation, denaturization, conformational changes are parameters that can be adjusted to achieve the desired physiological effect as a result of electromagnetic radiation.

It is notable that electromagnetic radiation, specifically illumination by light, interacts with the cell through the activation of light-receiving chemicals or chromophores. An example is the effect of certain red light, such as red light of wavelength 635 nm, which has activates the mitochondrial membrane protein Cytochrome c. Cytochrome c participates in cellular respiration as part of the electron transport pathway. Activation of Cytochrome c increases cellular respiration, which in turn increases the creation of ATP as a source of energy for the cell, which is metabolized to power cellular activities such as maintenance of cellular chemistry and electrolyte balance. These interactions are not limited to those cells containing fat or adipose material, and these interactions are potentially beneficial for all cells. It is furthermore notable that cells and organs that are awaiting transplant may be in a state of retarded respiration and retarded metabolism due to their removal from the body, reduction or elimination of blood flow, and possible hypothermia. So the present invention provides the beneficial ability to exogenously activate or regulate respiration and metabolism by the application of light to the explanted cell or organ. This application of light to regulate metabolism of the explanted cell or organ may prove safer or otherwise more feasible than alternate pharmaceutical, thermal, or other approaches.

In other embodiments, perfusion chamber conditions, such as temperature and/or temperature of the perfusate, may be adjusted to suit the type of organ and/or the desired outcome of the combination of perfusion and light therapy. Electromagnetic irradiation of target tissue can be performed when the organ or target tissue is subjected to various temperature conditions. Temperature conditions suitable for use with electromagnetic radiation of target tissue include normothermic and midthermic conditions, as well as providing graded intermittent hypothermia before and/or after periods of normothermia to combine the protective effects of hypothermia with targeted metabolic regulation during midthermia or normothermia to enable the physiologic response to the electromagnetic light source. Temperature programming during perfusion can be applied to achieve the modification of rate and distribution of tissue perfusion as known to one skilled in the art. Some of the beneficial effects of modulating the perfusion pressure described in U.S. Pat. No. 5,941,841, herein incorporated by reference, can also be used in combination with the present invention to provide desirable effects to the target tissue.

Perfusate suitable for use with perfusion during electromagnetic irradiation of target tissue include blood, diluted blood, leukocyte and or antibody depleted blood, plus synthetic bloods or perfusates such as the perfusates described in U.S. Pat. Nos. 4,415,556; 4,879,283; 6,946,241; 7,255,983; and 7,410,474 herein incorporated by reference. It is appreciated that light activated and chromophore molecules and cellular material may be furthermore included with the perfusate to beneficial effect.

In practice, the target organ is removed from its natural physiological environment and is placed in a perfusion environment such as a perfusion chamber, wherein factors such as duration of perfusion, temperature of perfusion, the type of perfusate, pulse frequency of the perfusate, is selected as known to one of ordinary skill in the art, to achieve the desired effect. The organ is examined to determine where fatty regions are located, and regions subjected to irradiation by electromagnetic energy are determined. The step of irradiation by electromagnetic energy comprises determining which regions of the organ the target tissue is located, and determining whether the target tissue should have direct contact with the irradiation source, such as by needle puncture or interluminally, or whether treatment should be administered at a pre-determined distance from the surface of the target tissue, or whether a combination of direct contact and remote treatment should be used. Because fatty tissue is irregular and prone to high concentrations in one region compared to another, the ability to address variations in surface adipose tissue by Gaussian beam modeling to determine the desired light intensity profile and shape, is one of the advantages of the present invention. Furthermore, if fatty tissue is determined to be beneath the surface of the organ, such as in the case of a fatty liver, the user can determine the location to which electromagnetic energy should be delivered, either intraluminally or by needle puncture. Alternatively, the intensity of electromagnetic radiation can be increased to suitable levels.

Once the type of delivery of electromagnetic radiation is determined, beam modeling can be used to achieve the desired effect on the target region. For example, an array of diodes can be arranged in a certain orientation such that the array of diodes, when set a pre-determined distance apart, will yield a concentration of power density that is suitable for the coverage area. In another embodiment, a combination of laser energy and electromagnetic energy can be used to achieve the desired electromagnetic intensity profile on the desired tissue. In other embodiments, an LED source can be placed in direct contact with the fatty tissue to cause the fat to be removed.

From the foregoing, it will be observed that numerous variations and modifications may be effected without departing from the spirit and scope of the invention. It is to be understood that no limitation with respect to the specific apparatus illustrated herein is intended or should be inferred.

All references, including publications, patent applications, and patents, cited herein are hereby incorporated by reference to the same extent as if each reference were individually and specifically indicated to be incorporated by reference and were set forth in its entirety herein, except where inconsistent with the present disclosure.

The invention claimed is:

1. A method of decreasing fat content on a harvested organ comprising the steps of:
subjecting cells of the harvested organ to electromagnetic energy at hypothermic conditions, said electromagnetic energy provided by at least one source.

2. The method of claim 1 wherein the cells comprise adipose cells on the surface of the harvested organ.

3. The method of claim 1 wherein the source is disposed at a pre-determined distance from the organ.

4. The method of claim 1 wherein the electromagnetic energy has a wavelength between 600 nm to 700 nm.

5. The method of claim 1 wherein the source is a laser.

6. The method of claim 1 wherein the source is a light emitting diode.

7. The method of claim 1 wherein the electromagnetic energy is provided by an array of lasers.

8. The method of claim 1 wherein the electromagnetic energy is provided by an array of light emitting diodes.

9. The method of claim 1 wherein the electromagnetic energy is provided by a combination of at least one laser and at least one light emitting diode.

10. The method of claim 1 wherein the cells comprise adipose cells, and the step of subjecting cells to electromagnetic energy comprises the step of:
disposing the source in contact with adipose tissue for a pre-determined period of time.

11. The method of claim 10 wherein the step of disposing the source in contact comprises the step of:
positioning one or more sources of electromagnetic energy into a desired orientation.

12. The method of claim 11 wherein one or more sources comprise at least a light emitting diode.

13. The method of claim 11 wherein one or more sources comprise at least a laser.

14. The method of claim 1 wherein the step of subjecting cells to electromagnetic energy comprises the step of:
placing the organ within a chamber for the purposes of preserving the organ within the chamber.

15. The method of claim 14 wherein the chamber is maintained at a hypothermic temperature.

16. The method of claim 14 wherein the organ undergoes perfusion within the chamber.

17. The method of claim 16 wherein the electromagnetic energy is pulsed;
and wherein the pulsed electromagnetic energy is delivered in coordination with perfusion.

18. The method of claim 1 wherein the electromagnetic energy is pulsed.

19. The method of claim 1 wherein illumination of the electromagnetic energy at the surface of the organ has at least 50% of peak intensity.

20. A method of improving cellular metabolic status of cells in a harvested organ, comprising the steps of:
subjecting cells of the harvested organ to electromagnetic energy at hypothermic conditions, said electromagnetic energy provided by at least one source.
